(19) United States
(12) Patent Application Publication
(10) Pub. No.: US 2009/0108591 A1
(43) Pub. Date: Apr. 30, 2009

(54) Storage Containers and Latch Systems for Storage Containers

(75) Inventor: Kevin De Vries, Monroe, IA (US)

Correspondence Address: DINSMORE & SHOHL, LLP, 1900 CHEMED CENTER, 255 EAST FIFTH STREET, CINCINNATI, OH, 45202, US

(73) Assignee: DEE ZEE, INC., Des Moines, IA (US)

(21) Appl. No.: 11/928,619

(22) Filed: Oct. 30, 2007

(51) Int. Cl. E05C 1/08; E05C 5/00

(52) U.S. Cl. 292/64; 292/138

(57) ABSTRACT

The present invention is directed to a latch assembly for releasably latching two components, including a latch base, a latch plate, and a latch pin, wherein the latch pin is moveable with respect to the latch base. The latch assembly may be part of a latch system which includes the latch assembly and a receiving assembly and which can be used in storage containers, such as, a vehicle storage container.

### FIELD

The present invention is directed to latches which can be used as closures for various items, including, for example, vehicle storage containers.

### BACKGROUND

While there are currently many different types of latches on the market, they all generally suffer from the same Achilles' heel, rigidity. If the shape of the structure to which the latch is attached changes with age, damage, etc. or manufacturing tolerances are off, the rigid latch is unable to compensate for these changes or miscues and will no longer fit into its receiving assembly. Once this happens, the structure will no longer be able to be latched shut. As such, a need exists for a latch which has at least some flexibility.

### SUMMARY

One embodiment of the present invention is directed to a latch assembly for releasably latching two components. The latch assembly includes a latch base, a latch plate, and a latch pin, wherein the latch pin is moveable with respect to the latch base.

Another embodiment of the invention is directed to a latch system for a vehicle storage container, where the storage container has an open and closed position and can be moved between those positions. The latch system includes a latch assembly secured to a first portion of the storage container and a receiving assembly secured to a second portion of the storage container. At least a portion of the latch assembly is moveable with respect to the receiving assembly.

In another embodiment, the invention is directed to a vehicle storage container. The vehicle storage container includes a container base, a container lid, and latch system. The latch system includes a latch assembly secured to one of the container lid or container base and a receiving assembly secured to the other of the container lid or container base, wherein at least a portion of the latch assembly is moveable with respect to the receiving assembly.

Additional embodiments, objects and advantages of the invention will become more fully apparent in the detailed description below.

### BRIEF DESCRIPTION OF THE DRAWINGS

The following detailed description will be more fully understood in view of the drawings in which:

FIG. 1 is an exploded view of a latch assembly according to one embodiment:

FIG. 2 is a perspective view of a latch assembly according to one embodiment:

FIG. 3 is a front view of a latch assembly showing moveability of the latch pin with respect to the latch base according to one embodiment;

FIG. 4 is a perspective view of a latch assembly on the container lid of a vehicle storage container according to one embodiment:

FIG. 5 is a perspective view of a receiving assembly attached to the container base a according to one embodiment;

FIG. 6 is a front view of a latch system for a vehicle storage container according to one embodiment; and

FIG. 7 is a perspective view of a vehicle storage container according to one embodiment.

The embodiments set forth in the drawings are illustrative in nature and are not intended to be limiting of the invention defined by the claims. Moreover, individual features of the drawings and the invention will be more fully apparent and understood in view of the detailed description.

### DETAILED DESCRIPTION

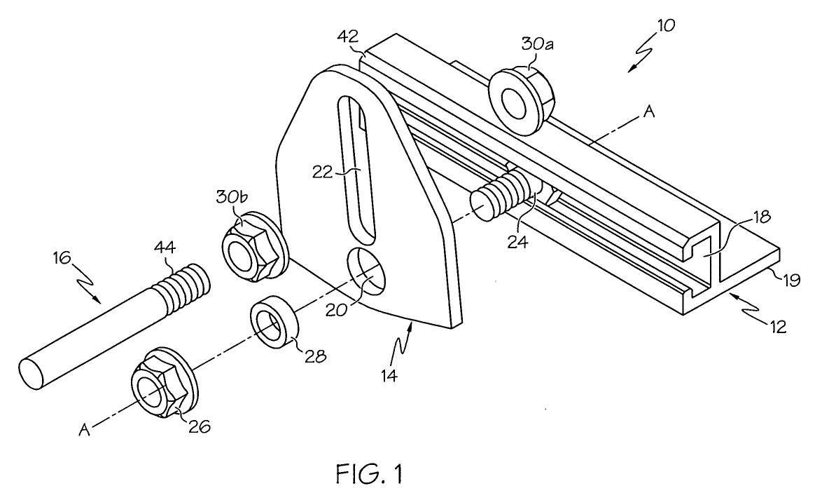

Referring to the drawing figures in detail, wherein like numerals indicate the same elements throughout the drawing figures. FIGS. 1-7 illustrate various embodiments of a latch system including a latch assembly and a receiving assembly for use with a vehicle storage container. Latches are generally used to hold two components together. They can be used, for example, in all sorts of doors, windows, containers, etc. The invention will be described in the context of its various configurations, however it should be appreciated that alternative arrangements of the invention can comprise any combination of such configurations. For example, features illustrated or described as part of one embodiment, can be used on another embodiment to make a further embodiment.

According to one embodiment of the present invention, a latch assembly 10 can be provided which includes a latch base 12, a latch plate 14, and a latch pin 16 (each of which is described with respect to components and operations more fully below). The latch base 12, latch plate 14, and latch pin 16 can be made of any suitable material, for example, metal, aluminum, stainless steel, plastic, etc. In addition, these components can be any suitable shape, for example, square, rectangle, triangle, circular, oval, elliptical, polygonal, and combinations thereof, etc. Other features can be added to the overall shape of the latch base 12, latch plate 14, and latch pin 16 in order to, for example, accommodate means of attachment or functionality. For example, the latch base 12 can have a C-shape which defines a channel 18 and the channel 18 can facilitate movement of the latch plate 14 and latch pin 16 from left to right and vice versa. As another example, the face of the latch plate 14 could contain a hole 20 and/or a slot 22, through which the latch plate 14 could be attached to the latch base 12 or the latch pin 16 and/or the latch pin 16 could be threaded on one end to help facilitate its attachment to and movement with respect to the latch plate 14.

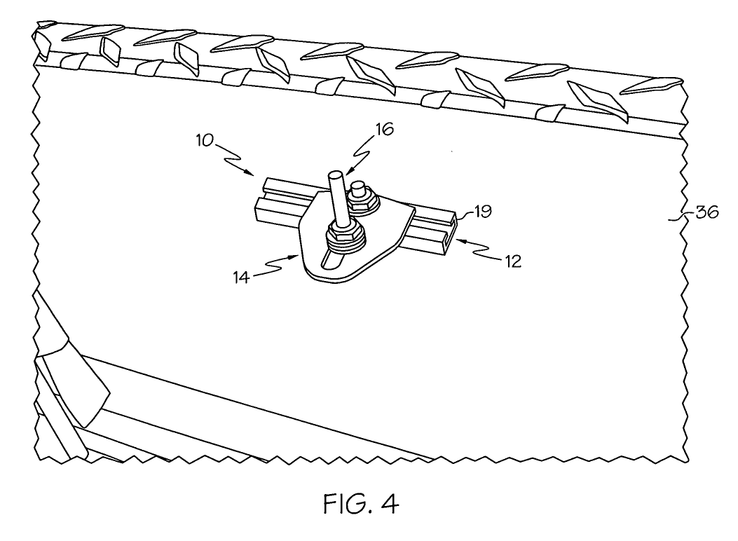

The latch base 12 will generally be mounted to one side of a closure, for example, a lid (e.g. FIG. 4), and can be either fixed or moveable. The latch base 12 may also comprise a mounting surface 19. The latch plate 14 is generally attached to the latch base 12 and can be either fixed or moveable. When moveable, the latch plate 14 is moveable with respect to the latch base 12. Similarly, the latch pin 16 is generally attached to the latch plate 14 and can be either fixed or moveable. When moveable, the latch pin 16 is moveable with respect to either the latch base 12 or the latch plate 14. Further, the components may be arranged in many combinations where, for example, some are moveable while others are fixed, all are moveable, all are fixed, or any combination of such, as described below.

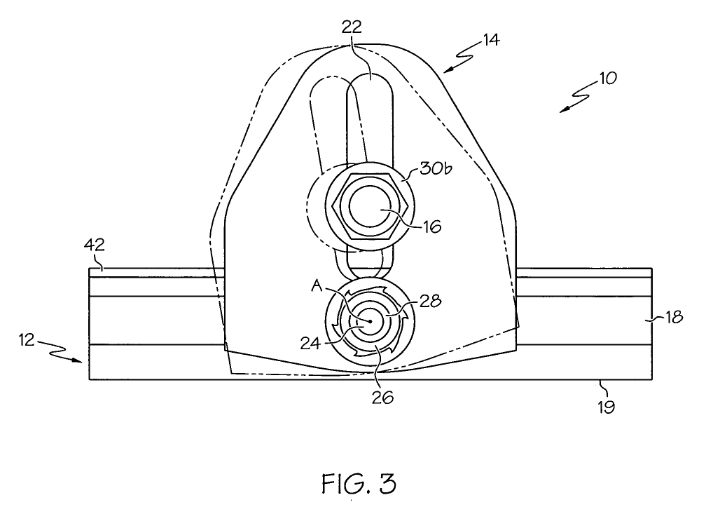

Referring to FIG. 3, the latch base 12, latch plate 14, and latch pin 16 can be moveable in many directions. For example, in one embodiment, the latch pin 16 is moveable with respect to the latch base 12 horizontally, vertically, or a combination thereof. The movement in these directions can occur in a straight line or in an angled variation, for instance, the movement could be a combination of horizontal and vertical movement because it is along an arcuate or curved path, or because it is moving diagonally upward or downward.

Moveability of the pieces can be affected, for example, by how the pieces are shaped and/or how they are connected. The latch base 12, latch plate 14, and latch pin 16 may be attached to their respective components by any suitable means. For example, they may be attached via welds, adhesives, screws, nails, nuts and bolts, clamps, rivets, etc. As will be understood by those skilled in the art, some of these attachment types will be more suited for fixed attachment (for example, welding) while others will be more suited for moveable attachment (for example, nuts and bolts). It should be noted, however, that many types of the attachment types listed above can be used for both moveable and fixed attachment, for example, nuts and bolts.

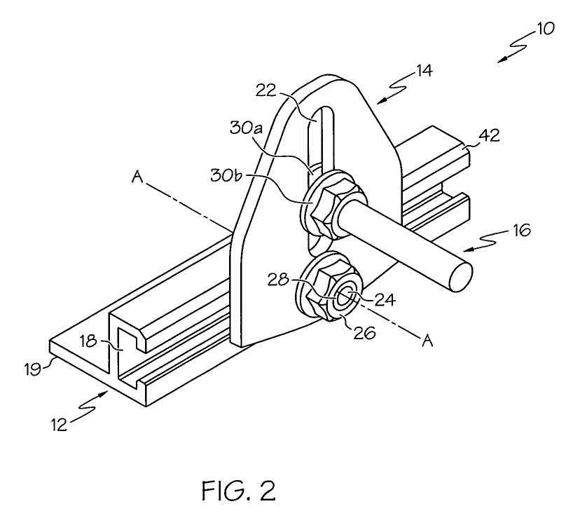

An example of how some of the pieces can be attached includes, the latch base 12 being fixedly attached to one portion of a closure via welding (e.g. FIG. 4). The latch plate 14 could be attached to the latch base 12 with a nut and bolt mechanism (e.g. FIGS. 1-2). In another embodiment, the latch pin 16 can be attached to the latch plate 14 using at least one nut. This nut could be, for example, a flange locknut 30. The flange locknut 30, similar to the nylon locknut 26 below, acts to prevent the loosening of the latch pin 16 during the movement of the latch assembly 10.

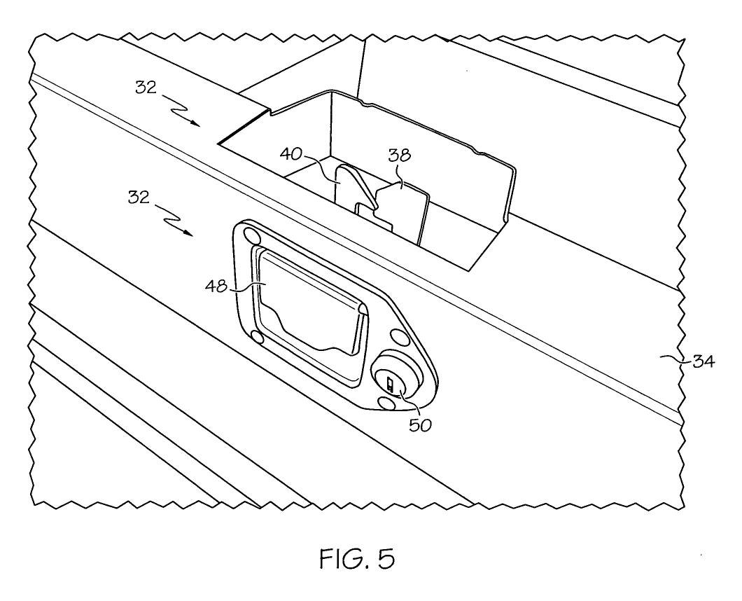

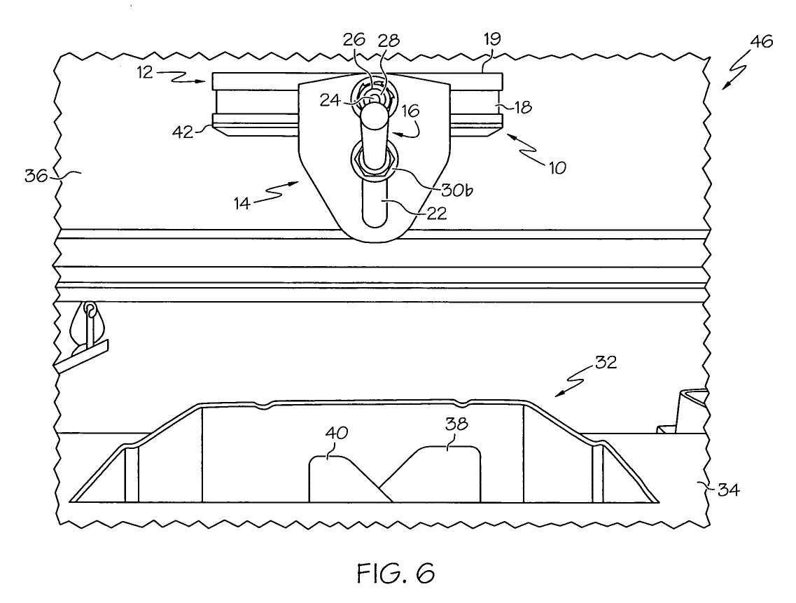

Referring to FIGS. 5-6, the latch system 16 may also incorporate a receiving assembly 32. The receiving assembly 32 is configured to releasably retain the latch pin 16. Thus, the receiving assembly 32 will generally be located on a portion of an item opposite to the latch assembly 10 as these two pieces work in harmony to close an item. For example, looking to FIGS. 4-7, in a vehicle storage container, the receiving assembly 32 would be located on the container base 34, while the latch assembly 10 would be located on the container lid 36. These opposing locations allow for the latch pin 16 to be releasably engaged by the receiving assembly 32 and thus close the box. The receiving assembly 32 can be of any appropriate size, shape, and material as long as it will releasably engage the latch pin 16. For example, as seen in FIGS. 5-6, the receiving assembly 32 can include two opposable sides 38, 40, wherein the sides 38, 40 are configured to move away from one another upon receiving the latch pin 16 and further configured to move back toward each other and releasably engage the pin 16 upon completion of receipt. The receiving assembly may further include a release plate 48 which allows for the receiving assembly 32 to disengage the latch pin 16 and a lock 50. In another embodiment, the receiving assembly 32 further includes a guide plate (not pictures). In an additional embodiment, the receiving assembly 32 can be a rotary latch (not pictured) with either a single or dual rotar.

As can be seen from the above, the latch assembly 10 can involve many different variations of the latch base 12, latch plate 14, latch pin 16, and receiving assembly 32 including varying materials, shapes, and connections, and still fall within the scope of this application. To simplify the rest of the discussion, the detailed mechanics of the latch assembly 10 (without the receiving assembly) will be described with reference to one particular embodiment. However, it will be appreciated that the invention encompasses other embodiments and other uses in light of the disclosure above and that generally known in the art.

According to one particular embodiment, the latch assembly 10 includes a latch base 12. The latch base 12 is made of aluminum and has a C-shape with a tail as can be seen in FIG. 1. The C-shape of the latch base forms a channel 18. This channel 18 can serve multiple functions which will be described in further detail below. The latch plate 14 has a uniform shape which is wider at the base and narrows as it gets to the top, which can be seen in FIG. 1. The latch plate 14 is generally made of aluminum and comprises a hole 20 and a slot 22. A nut and bolt mechanism is used to connect the latch plate 14 to the latch base 12 through the hole 20. The head of the bolt 24 in the nut and bolt mechanism fits into the channel 18 on the latch base 12. The channel 18 effectively hides the head of the bolt 24 to give the latch assembly 10 a more finished look and keeps the head of the bolt 24 from rotating. Therefore, the size of the bolt 24 and the channel 18 should be adjusted appropriately for maximum performance. The channel 18 also allows for manual adjustment of the location of the latch plate 14 along the latch base 12. Thus, if manufacturing tolerances make the location of the plate 14 slightly off from where it needs to be, the user can loosen the nut and bolt mechanism and slide the latch plate 14 along the channel 18 of the latch base 12 to the appropriate position.

The use of a specific nut and bolt mechanism to connect the latch plate 14 and latch base 12 brings additional benefits. In one embodiment, the nut and bolt mechanism comprises a bolt 24, a nylon locknut 26, and a nylon standoff 28. This particular nut and bolt mechanism allows the latch plate 14 to be locked into one place on the latch base 12 but to maintain an ability to pivot (FIG. 3). The use of a nylon locknut 26 prevents the loosening of the nut during the pivoting of the latch plate 14 and the nylon standoff 28 reduces binding due to the tightening of the locknut 26. Thus, the use of the nylon locknut/standoff contributes to the moveability of the plate 14 in an arcuate motion. The moveability of the plate 14 in this way can also be increased by altering the shape of the plate 14. For instance, rounding the bottom of the plate 14, as can be seen in FIG. 3, allows for more clearance between the plate 14 and the top of the closure (or whatever else the latch assembly is attached to) and thus gives it more room to pivot.

The latch pin 16 is generally threaded on one end and is attached to the latch plate 14 using at least one nut. In this particular embodiment, the latch pin 16 is attached to the latch plate 14 by sliding the threaded end of the latch pin 16 through the slot 22 in the latch plate 14 and screwing a flange locknut 30a onto the threaded portion of the latch pin which ends up on the back side of the latch plate 14. An additional locknut 30b is then slid over the unthreaded end of the pin 16 until it reaches the threaded end of the pin 16 on the front side of the latch plate 14 and then is screwed onto the threads until it rests against the front side of the latch plate 14 holding the pin 16 in place. The pin 16 can be adjusted in an axial (in/out) direction by changing how much of the threading of the pin 16 is located on the front versus the back of the latch plate 14. Thus, by having more threading on the front side of the latch plate 14, the pin 16 is longer and vice versa. The pin 16 may also be manually adjusted vertically by loosening at least one of the locknuts 30a, 30b and sliding the pin 16 up/or down in the slot 22 located on the latch plate 14. The vertical adjustability of the pin can be limited by an obstruction of the slot 22 by the latch base 12. To help alleviate the obstruction, the latch base 12 can further comprise a chamfer 42. The chamfer 42 will generally be located on the lop edge of the latch base 12 located closest to the plate 14. By adding the chamfer 42, the obstruction caused by the meeting of the latch base 12 and the latch plate 14 is lowered, allowing the locknut 30a to drop lower in the slot 22 and thus giving more adjustability to the pin 16 in the vertical direction.

The latch pin 16 comprises an engaging surface 44, wherein the engaging surface 44 is configured to allow for self adjustment in the depth of the latch assembly 10. The engaging surface 44 of the pin 16 comprises at least a portion of the surface of the pin 16 which resides on the front side of the latch plate 14. The length of this surface 44 allows for the self adjustment of depth. Thus, if manufacturing tolerances or damage to the closure make the latch assembly 10 (and thus the pin 16) further away from the receiving assembly 32, the length of the pin 16 will compensate for that change as long as it is not greater than the length of the pin 16. This type of need for self adjustment is often seen in vehicle tool boxes because the user will grab the container base 34 and pull on the container base 34 to slide the toolbox closer to the user. This often results in an outward bowing of the base of the toolbox, the inability of an inflexible latch assembly to compensate for the bowing of the container base, and thus the loss of the ability to latch the toolbox. The ability of the latch assembly 10 to compensate for these types of changes or misalignments without any adjustment of the latch assembly 10 by the user is considered self adjustment. If the user has to adjust the latch assembly 10, this is considered manual adjustment.

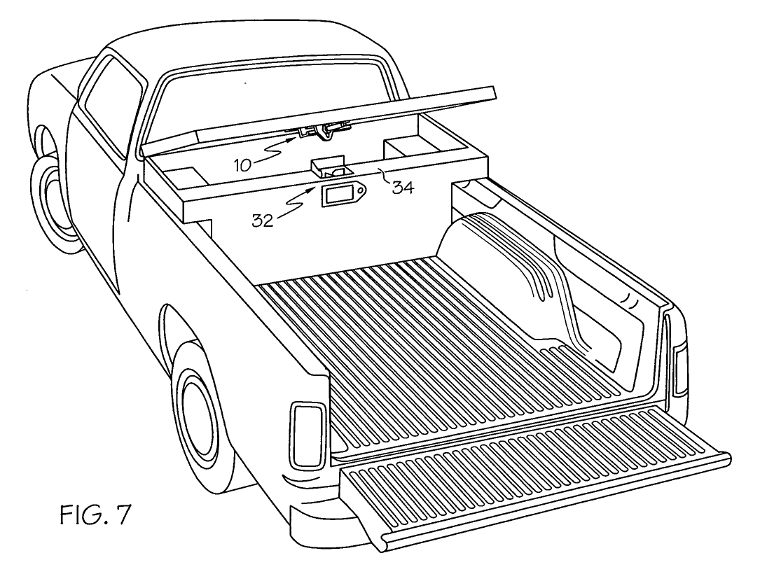

In operation, as seen in FIGS. 6-7, a latch system 46, as described above, can be used in a storage container, like a vehicle storage container 52. The vehicle storage container 52 includes a container base 34, a container lid 36, and a latch system 46. The vehicle storage container 52 can have an open and closed position and can be moved between those positions. The latch system 46 includes a latch assembly 10 secured to a first portion 36 of the storage container and a receiving assembly 32 secured to a second portion 34 of the storage container. At least a portion of the latch assembly 10 is moveable with respect to the receiving assembly 32.

Thus, as the container lid 36 is moved toward the container base 34 the user can gauge whether the latch assembly 10 needs to be manually adjusted. If manual adjustment of the latch pin 16 is needed, then the user can loosen the nut 30a, slide the latch pin 16 to the new position (either up or down) and tighten the nut 30a to keep the latch pin in the new position. If manual adjustment of the latch plate 14 is needed, then the user can loosen the nut 26 and slide the latch plate 14 (to the left or right), and then tighten the nut 26 to keep the latch plate in the new position. Additionally, when the latch assembly 10 comes into contact with the receiving assembly 32, the latch assembly 10 pivots (either to the left or right) in order to self correct for any misalignment of the latch assembly 10 and the receiving assembly 32. As the latch assembly 10 self corrects, the latch pin 16 pushes against at least one of the opposable sides 38, 40 acting to push the opposable sides 38, 40 apart. The opposable sides 38, 40 slide far enough apart to allow the latch pin 16 to slide between them. Once the pin 16 slides between the opposable sides 38, 40, the two sides return to their original positions and thus releasably engage the latch pin 16. To disengage the latch pin 16, the user can lift the release plate 48 which will pull the opposable sides 38, 40 apart and allow the user to lift the container lid 36 thus pull the latch pin 16 out from between the two opposable sides 38, 40.

The foregoing description of various embodiments and principles of the invention has been presented for the purposes of illustration and description. It is not intended to be exhaustive or to limit the inventions to the precise forms disclosed. Many alternatives, modifications, and variations will be apparent to those skilled the art. Moreover, although multiple inventive aspects and principles have been presented these need not be utilized in combination, and various combinations of inventive aspects and principles are possible in light of the various embodiments provided above. Accordingly, the above description is intended to embrace all possible alternatives, modifications, aspects, combinations, principles, and variations that have been discussed or suggested herein, as well as all others that fall within the principles, spirit and scope of the inventions as defined by the claims.

What is claimed is:

1. A latch assembly for releasably latching two components, comprising a latch base, a latch plate, and a latch pin, wherein the latch pin is moveable with respect to the latch base.

2. The latch assembly of claim 2, wherein the latch pin is moveable horizontally, vertically, or a combination thereof.

3. The latch assembly of claim 2, wherein the latch pin is moveable horizontally along an arcuate path.

4. The latch assembly of claim 2, wherein the latch plate is attached to the latch base via a nut and bolt mechanism.

5. The latch assembly of claim 4, wherein the nut and bolt mechanism comprises a bolt, a nylon locknut, and a nylon standoff.

6. The latch assembly of claim 5, wherein the latch pin passes through a slot on the latch plate and is attached to the latch plate via at least one nut.

7. The latch assembly of claim 6, wherein the at least one nut comprises a flange locknut.

8. The latch assembly of claim 1, wherein the latch pin comprises an engageable surface, wherein the engageable surface is configured to allow for self adjustment in depth.

9. The latch assembly of claim 1, wherein the latch pin is moveable with respect to the latch plate.

10. The latch assembly of claim 1, wherein the latch base further comprises a chamfer.

11. The latch assembly of claim 1, further comprising a receiving assembly, wherein the receiving assembly is configured to releasably retain the latch pin.

12. The latch assembly of claim 10, wherein the latch assembly is used in a storage container.

13. A latch system for a vehicle storage container, the storage container having an open and closed position, the latch system comprising a latch assembly secured to a first portion of the storage container and a receiving assembly secured to a second portion of the storage container, wherein when said storage container is moved between said open and closed position, at least a portion of the latch assembly is moveable with respect to the receiving assembly.

14. The latch system of claim 12, wherein the latch assembly is moveable horizontally, vertically, or a combination thereof.

15. A vehicle storage container, comprising a container base, a container lid, and latch system, wherein the latch system comprises a latch assembly secured to one of the container base or container lid and a receiving assembly secured to the other of the container base or container lid, and wherein at least a portion of the latch assembly is moveable with respect to the receiving assembly.

16. The vehicle storage container of claim 15, wherein the latch assembly comprises a latch base, a latch plate, and a latch pin, wherein the latch pin is moveable with respect to the latch base.

17. The vehicle storage container of claim 16, wherein the latch base and the latch plate are connected with a nut and bolt mechanism which comprises a bolt, a nylon locknut, and a nylon standoff.

18. The vehicle storage container of claim 15, wherein the latch plate and the latch pin are connected with at least one flange locknut.

19. The vehicle storage container of claim 16, wherein the latch base further comprises a chamfer.

20. The vehicle storage container of claim 15, wherein the receiving assembly comprises two opposable sides, wherein the opposable sides releasably engage the latch pin when the container lid is seated on the container base
